(19) United States
(12) Patent Application Publication
(10) Pub. No.: US 2004/0189073 A1
(43) Pub. Date: Sep. 30, 2004

(54) Adjustable chair

(76) Inventors: Donald Chadwick, Los Angeles, CA (US); Francisco Romero, Venice, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/401,514

(22) Filed: Mar. 28, 2003

(51) Int. Cl. B60N 2/02

(52) U.S. Cl. 297/383

(57) ABSTRACT

A desk chair that is adjustable to accommodate a variety of different body sizes and shapes, and particularly to accommodate changes in body size and shape of children over several years between young childhood and adulthood. The chair includes a seat, a back support, and a pair of arm rests on opposite sides of the seat. The chair has adjustment mechanisms that allow the chair to be adjusted in several different ways, including the depth of the seat, the heights of the back support and the arm rests, and the positions of the arm rests in a substantially lateral plane relative to the seat and the back support. The chair also has a mechanism for adjusting the height of the seat over a range which is especially adapted for growing children, which results from positioning a height control adjustment mechanism substantially entirely within a support base for the chair, extending downwardly between the legs. In addition, the chair is designed to tilt about four pivot points under the control of a tilt control mechanism, with the four pivot points forming the vertexes of a substantial parallelogram, so that as the back support tilts the seat tilts to a lesser extent. The tilt control mechanism includes a self-centering crank arm for adjusting the resistance of the mechanism to tilting.

### FIELD OF THE INVENTION

The present invention relates generally to home or office furniture, and more specifically, to a desk chair that is adjustable to accommodate a variety of different body sizes and shapes, and particularly to accommodate changes in body size and shape of children over several years between young childhood and adulthood.

### BACKGROUND OF THE INVENTION

Desk chairs for home or office typically include a chair frame mounted on a support base. The frame typically includes a seat, a back support and a pair of arm rests on opposite sides of the chair, positioned above the seat and forward of the back support. In some desk chairs, the seat is firmly mounted on the support base, with the back support movably mounted for tilting relative to the seat. In other desk chairs, the frame is movably mounted to the support base such that the chair is designed to allow tilting of the seat and back support in unison relative to the support base.

Prior art desk chairs are known to come in different sizes to accommodate adults or children. In desk chairs of all sizes, the height of the chair frame may be adjustable within a predetermined range such that the entire chair frame (seat, back support, and arm rests) can be raised or lowered to a desired height in order to allow the user to sit in the chair with the user's feet resting comfortably on the floor. Some desk chairs also allow other adjustments, such as the angle of the seat and/or the back support.

Prior art desk chairs, whether sized for adults or children, are limited, however, in their ability to adjust to accommodate a variety of different body sizes and shapes. This can be an issue with adults who are relatively large or small, but it is a particular problem for children because of the amount of change in body size and shape of children they experience between young childhood and adulthood.

According to United States census reports, the mean height of a child increases from approximately 44 inches (112 cm.) at age 5 to approximately 69 inches (174 cm.) at age 19, an increase of over 56%. Even within smaller age groupings the differences in height are substantial between the shortest and tallest children. For example, the increase in height between a 5 year old child in the 5th percentile, approximately 42 inches (106 cm.), and an 11 year old child in the 95th percentile, approximately 61 inches (154 cm.), is 19 inches (48 cm.) or over 45%. Similarly, the increase in height between a 12 year old in the 5th percentile, about 55 inches (139 cm.), and a 19 year old in the 95th percentile, about 74 inches (188 cm.), is also 19 inches (48 cm.) or nearly 35%. This data is from Norris, B. and Wilson, J., Consumer Safety Unit, CHILDDATA, The Handbook of Child Measurements and Capabilities, Data for Design Safety (“CHILDDATA”), Section 1.1 (Snyder 1977).

Similar differences exist in popliteal heights for children. Popliteal height is the vertical distance from the floor to the popliteal angle, which is the underside of the knee when the child sits with hips and knees at 90 degrees. For example, based on British government findings, the mean popliteal height for a male increases from approximately 11 inches (27 cm.) at age 5 to approximately 18 inches (45 cm.) at age 18, which is an increase of 7 inches (18 cm.) or over 65%. Again, even within smaller age groupings the differences are substantial between the shortest and tallest children. The increase in popliteal height between a 5 year old male child in the 5th percentile, approximately 9 inches (24 cm.), and an 11 year old child in the 95th percentile, approximately 17 inches (42 cm.), is 8 inches (20 cm.) or over 75%. Similarly, the increase in height between a 12 year old in the 5th percentile, about 14 inches (35 cm.), and an 18 year old in the 95th percentile, about 19 inches (49 cm.), is 5 inches (13 cm.) or over 38%. The increases in popliteal height for female children between the same ages are similarly substantial. This data is from CHILDDATA, Section 1.5 (Pheasant 1988).

Prior art desk chairs generally do not accommodate these changes and variances in children's body sizes and shapes. For example, prior art desk chairs generally do not permit adjustment of the depth of the sitting surface of the seat, that is, the distance between the front edge of the seat and the back support. This can be a problem for persons of all ages with shorter than average legs, and particularly children, because they may have to sit forward in the chair for their feet to rest comfortably on the floor even when the chair frame is adjusted to the appropriate height. As a result, such persons may have to place a pillow or pad between the back support of the chair and their own back in order to provide upper or lower lumbar support. This is usually not very convenient or comfortable and can cause back and neck problems over time and continued use.

The lack of adjustment of seat depth also can be a problem for persons with longer than average legs because the crooks of their knees may then extend beyond the front edge of the seat. As a result, such users may not have adequate support for their knees and thighs, and may tend to slide out of the chair, both of which, again, may lead to discomfort and physical problems.

Another limitation of prior art desk chairs is the inability to adjust the height of the back support. This can be a problem for taller persons and growing children to the extent that the back support is not sufficiently high to provide proper support for the upper back and shoulders.

A further limitation of prior art desk chairs is the lack of adjustability of the width of the distance between the arm rests. This can be a problem for smaller persons, including children, in that they may have to spread their arms relatively far apart for their elbows and forearms to rest on the arm rests. Conversely it can be a problem for larger persons and growing children because they may find the distance between the arm rests to be too restrictive for comfortable seating.

In each of the foregoing respects desk chairs tend to be fixed in size to accommodate a user of average height and proportions within the category of user for which the chair is designed, i.e., adult or child. This can be a problem for adults whose size is well above or below average, but it is a particular problem for children due to their rapid growth between young childhood and adulthood.

Accordingly, it will be appreciated that there is a need for a desk chair that is adjustable to accommodate a variety of body shapes and sizes. In particular there is a need for an adjustable desk chair one that accommodates changes in the body shapes and sizes of children between young childhood and adulthood, such that the chair may remain useful as the child continues to grow. The present invention fulfills these needs and provides other advantages as described herein.

### SUMMARY OF THE INVENTION

Briefly, and in general terms, the present invention resides in a desk chair that is adjustable to accommodate a variety of different body shapes and sizes. Although the adjustable desk chair of the present invention is useful for adults, it is particularly suitable for children between young childhood and adulthood, with the chair adjustable to accommodate changes in the body shape and size of the child over several years.

In accordance with the invention, the chair includes a seat and a back support, and also may include a pair of arm rests on opposite sides of the seat. The chair preferably has adjustment mechanisms that allow the chair to be adjusted in several different ways. For example, the chair may have an adjustment mechanism that allows selective adjustment of the depth of the sitting surface of the seat. This adjustment mechanism also may allow adjustment of the heights of the back support and the optional arm rests at the same time, all as part of a single adjustment movement. Releasable locking members preferably may be provided to releasably lock the back support and the arm rests in a selected position relative to the seat.

More specifically, in a presently preferred embodiment, the back support may be movably coupled to at least one support frame member for positioning the back support above and proximate the rear edge of the seat. The back support is selectively movable relative to this support frame member in the fore and aft direction with respect to the seat, movement of the back support away from the seat increasing the depth of the sitting surface of the seat, and movement of the back support toward the seat decreasing the depth of the sitting surface of the seat. By adjusting the back support forward, the chair can accommodate users with shorter legs including children, and by adjusting the back support rearward, the chair to accommodate users with longer legs, including children as their legs grow.

Preferably the support frame member may form a generally oblique angle with the sitting surface of the seat, such that forward movement of the back support decreases both the depth of the sitting surface of the seat and the height of the back support for a smaller user, and rearward movement of the back support increases both the depth of the sitting surface of the seat and the height of the back support for a larger user or growing child. The arm rest may be coupled to the back support such that the height of the arm rest increases or decreases with the height of the back support. In the presently preferred embodiment, the back support and the first support frame member may be sized and shaped for interlocking engagement so as to allow the back support to slide relative to the first support frame member. The arm rest similarly may be sized and shaped for interlocking engagement with the back support or the first support frame member for sliding movement as well.

The means for releasably locking the back support to the support frame member in a selected position relative to the seat may include a locking member carried by the back support frame or the support frame member, and a recessed area in the other of the back support frame or the support frame member for selectively receiving the locking member. Where back support frame or the support frame member is hollow, the recessed area can take the form of an opening in the outer wall. Preferably, the recessed area may be elongated and the locking member may comprise a threaded adjustment knob, so that the position of the back support may be continuously adjustable relative to the seat over substantially the length of the recessed area.

In another aspect of the invention, the chair may have an adjustment mechanism for adjusting the positions of the arm rests in a substantially horizontal or lateral plane relative to the seat and the back support. This adjustment mechanism preferably may allow adjustment of the arm rests either in the rearward-and-inward direction for a smaller user, or in the forward-and-outward direction for a larger user or growing child, so that the arm rests are neither too far apart nor too restrictive for comfort and support. Releasable locking members preferably may be provided to releasably lock the arms rests in selected positions. Alternatively, the arm rests are fully removable in case no arm support is desired.

In a presently preferred embodiment, the arm rest may comprise an arm rest frame member and an arm pad member movably coupled to the arm rest frame member. The arm pad member may be movable in a lateral plane at an oblique angle relative to the side edges of the seat, such that movement of the arm pad member in one direction results in forward-and-outward adjustment of the position of the arm pad member relative to the seat and the back support, and movement of the arm pad member in the opposite direction results in rearward-and-inward adjustment of the position of the arm pad member relative to the seat and the back support. The arm rest frame member and the arm pad member may be sized and shaped for interlocking engagement so as to allow the arm pad member to slide relative to the arm rest frame member. Means for releasably locking the arm pad member to the arm rest frame member may comprise a locking mechanism carried by the arm pad member or the arm rest frame member, and an opening in the other of the arm pad member or the arm rest frame member for selectively receiving the locking member.

In another aspect of the invention, a mechanism may be provided for adjusting the height of the seat over a range that is especially adapted for growing children. To this end, the chair may include a support base comprising a plurality of radially-outwardly and downwardly extending legs, and a height control adjustment mechanism coupled to and supporting the seat above the support base. Preferably, in order to achieve the desired range of height adjustment, a height control housing unit for housing the height control adjustment mechanism may be contained substantially entirely within the support base, extending downwardly between the legs.

In a further aspect of the invention, the chair may provide for tilting of the back support and the seat about several pivot points under the control of a tilt control mechanism. More specifically, in a presently preferred embodiment, the chair may have a base member positioned generally below the seat, and first and second support frame members each having one end coupled to the seat and the other end coupled to the base member. The first support frame member and the second support frame member may be disposed in spaced apart relationship, and one end of the first support frame member or the second support frame member may be coupled via the tilt control mechanism to form one pivot point. The remaining ends of the first support frame member and the second support frame member may be pivotally coupled to form at least three other pivot points. The back support may be connected to at least one of the support frame members for tilting movement relative to the seat. Preferably, these four pivot points form the vertexes of a substantial parallelogram, with the forward side of the parallelogram represented by the first support frame member and the rearward side of the parallelogram represented by the second support frame member. The second support frame member may be somewhat shorter than the first support frame member so that as the back support tilts the seat also tilts, but to a lesser extent.

The adjustable tilt control mechanism may include a crank arm with a ratchet-like mechanism for adjusting the resistance to tilting of the tilt control mechanism by repetitive pivoting of the crank arm from a center position to one side. In another aspect of the invention, the crank arm may be self centering. Specifically, in a presently preferred embodiment, the tilt control mechanism may include a spring member having first and second ends, one of which is engaged by a portion of the crank arm and the other of which is engaged by a stop in the tilt control mechanism, depending on which direction the crank arm is pivoted from the center position. When the crank arm is pivoted from center in one direction, the crank arm engages and pushes the first end of the self-centering spring member, while the stop holds the second end of the spring member in place. When the crank arm is pivoted in the opposite direction, the crank arm engages and pushes the second end of the self-centering spring member, while the stop holds the first end of the spring member in place. As the crank arm is pivoted in either direction from the center position, the spring member is loaded so that it exerts a force tending to return the crank arm to the center position.

The foregoing features may be used in separately or in any combination. Other features and advantages of the invention will become apparent from the following detailed description of the preferred embodiment, taken in conjunction with the accompanying drawings, which illustrate, by way of example, the principles of the invention.

### BRIEF DESCRIPTION OF THE DRAWINGS

The invention will now be described in detail with reference to the presently preferred embodiments shown in the drawings, which are provided only as an example to illustrate the principles of the invention. The invention is not limited to the embodiments shown, and variations within the scope of the invention will be apparent to those skilled in the art. The embodiments are not shown or described in more detail than necessary to describe the invention, and the manner and process of making and using it, to those skilled in the art.

In the drawings:

FIG. 1 is a perspective view of a preferred embodiment of an adjustable chair in accordance with the invention;

FIG. 2 is a rear elevation view of the adjustable chair shown in FIG. 1;

FIG. 3 is an exploded view of components of the adjustable chair shown in FIG. 1;

FIG. 4 is a side elevation view of the adjustable chair of FIG. 1 illustrating the range of adjustment of a back support and arm rests of the chair relative to a seat;

FIG. 5 is a perspective view of the adjustable chair of FIG. 1 in which the arm rests have been removed;

FIG. 6 is an exploded view of an adjustable arm assembly from the left side of the adjustable chair shown in FIG. 1;

FIG. 7A is an exploded view from the bottom of various components of the adjustable arm assembly of FIG. 6, and FIG. 7B shows the components of FIG. 7A in an assembled state;

FIG. 8 is a plan view illustrating various positions of the adjustable arm rests of the adjustable chair shown in FIG. 1 as the arm rests are adjusted between forward-and-outward positions and rearward-and-inward positions;

FIGS. 9A and 9B are partial perspective views from the front and from the rear, respectively, of a tilt control housing unit of the adjustable chair shown in FIG. 1, the tilt control housing unit having a tilt control crank arm and a pneumatic lever arm;

FIG. 10 is an exploded view from the rear of the tilt adjustment housing unit of FIG. 9A;

FIG. 11 is an exploded view of a self-switching and self-centering ratchet mechanism assembly contained within a ratchet housing on the inner end of the tilt control crank arm and a lead screw and associated component to which the ratchet mechanism is coupled on the underside of the bottom casing shell of the tilt control housing unit;

FIG. 12 is a perspective view of the assembled ratchet mechanism of FIG. 11 in the ratchet housing on the inner end of the tilt control crank arm, shown coupled to a lead screw through an opening in the bottom casing shell of the tilt control housing unit;

FIG. 13 is an enlarged cross-sectional view of the tilt control housing unit taken along the line 13-13 in FIG. 9A;

FIG. 14 is an enlarged cross-sectional view, partially broken away, of the ratchet mechanism taken along the line 14-14 in FIG. 13, with certain components of the ratchet mechanism shown in phantom;

FIG. 15 is a bottom plan view of the tilt control housing unit including the tilt control crank arm;

FIG. 16 is a side elevation view of the adjustable chair of FIG. 1 illustrating various positions of the back support and seat as the chair tilts forward and rearward about several pivot points;

FIG. 17A is a diagrammatic illustration of the component parts of a pneumatic mechanism of the adjustable chair shown in FIG. 1 in a lowered position, and FIG. 17B is a diagrammatic illustration of the component parts of the pneumatic mechanism in a raised position;

FIG. 18 is a side elevation view of the adjustable chair of FIG. 1 illustrating the range of adjustment in the height of the chair; and

FIG. 19 is a perspective view of an alternative embodiment of an adjustable chair without the tilt control housing unit in accordance with the invention.

### DETAILED DESCRIPTION OF PREFERRED EMBODIMENTS

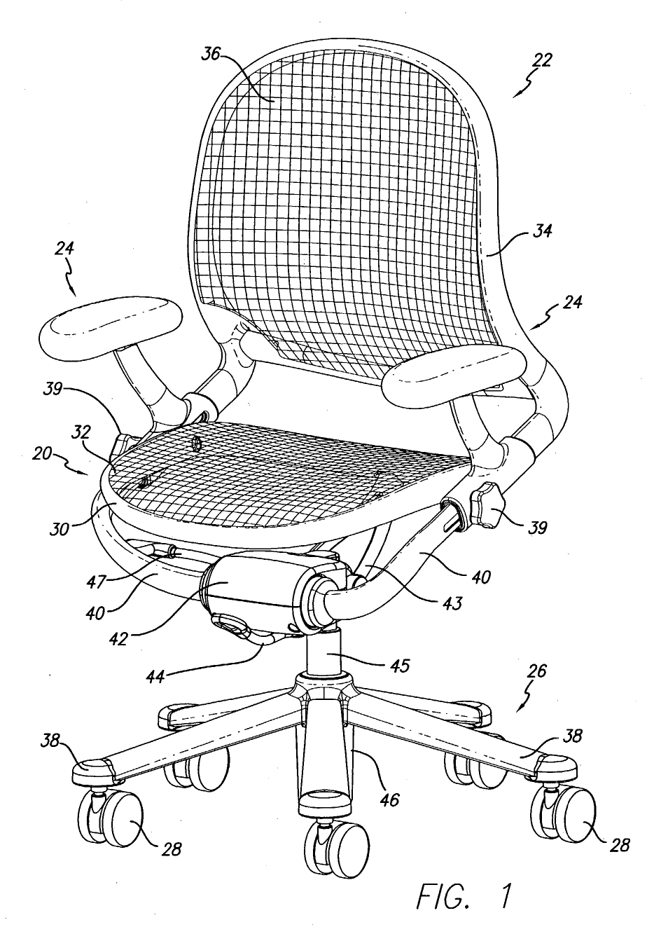

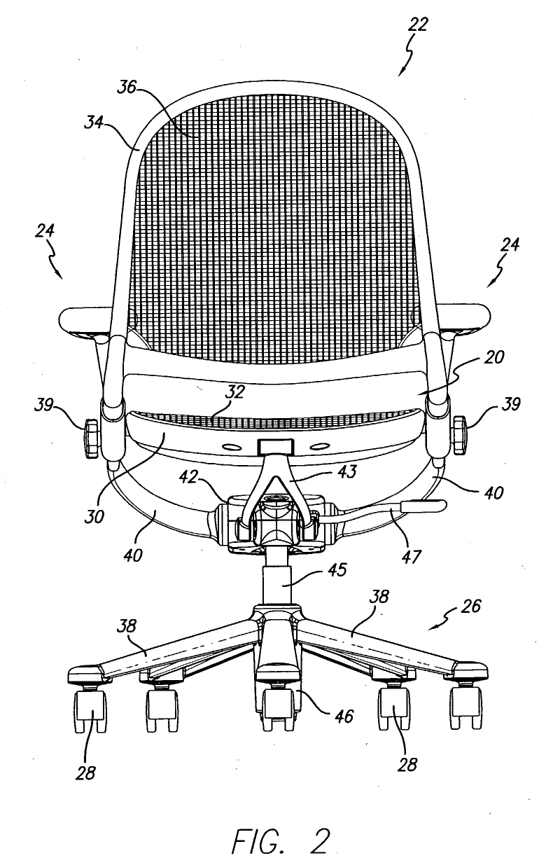

Referring now to the drawings, and particularly to FIGS. 1-2 thereof, there is shown by way of example an adjustable chair in accordance with a preferred embodiment of the present invention. The preferred embodiments described herein are intended to accommodate changes in body size and shape of a child in the age range from about 5 to 11 years or older. The child may then graduate to a larger adjustable chair of similar design that would satisfy his or her needs from about age 12 years to age 18 years and on into adulthood. However, adjustable chairs intended to satisfy the needs of users in any age range are within the scope of the invention.

As shown, the chair includes a seat, indicated generally by reference numeral 20, an adjustable back support 22 coupled to the seat, a pair of adjustable arm rests 24 located on opposite sides of the seat, and a support base 26 having a plurality of wheels or casters 28 to allow the chair to roll along a surface for movement. The seat comprises a seat frame 30 and a seat member 32 to support the buttocks, thighs and knees of the user, and the back support similarly comprises a back support frame 34 and a back support member 36 to provide support to the lumbar and thoracic regions of the user. The support base comprises a conventional spoke-like arrangement of angularly-spaced, radially-outwardly and downwardly extending legs 38 to which the casters are pivotally mounted at the legs' outer ends.

As will be described, the chair has adjustment mechanisms that allow selective adjustment of the depth of the seat 20 and the heights of the back support 22 and the arm rests 24, as well as the positions of the arm rests in a substantially horizontal or lateral plane relative to the seat and the back support. Releasable locking members in the form of a pair of adjustment knobs 39 are provided to releasably lock the back support and the arm rests in a selected position relative to the seat. Releasable locking members are also provided to releasably lock the arms rests in selected lateral positions, as described in detail below.

The chair further provides for tilting of the back support 22 and the seat 20 about several pivot points under the control of a tilt control mechanism, as also described in detail below. In this regard, the seat frame 30 and the back support frame 34 are supported by a pair of support frame members or front links 40 above a base member in the form of a tilt control housing unit 42. The front links are operatively coupled at their forward ends to the tilt control mechanism in the tilt control housing unit, and are pivotally coupled to the sides of the seat frame near their rearward ends, where they connect to the back support frame. The seat frame is further supported by another support frame member or tail link 43, which is pivotally coupled at its forward end to the rear of the tilt control housing unit and is pivotally coupled at its rearward end to the rear of the seat frame. A tilt control crank arm 44 is provided for adjusting the tilt control mechanism housed within the tilt control housing unit.

The tilt control housing unit 42 preferably is mounted to the top of a height control mechanism in the form of a telescoping pneumatic mechanism 45 that is contained within a height control housing unit 46 in the support base 26. A pneumatic lever arm 47 extends from the tilt control housing unit 42, for controlled adjustment of the height of the seat 20 to accommodate a desired range of popliteal heights, and in particular to accommodate the wide ranges in popliteal height encountered among growing children.

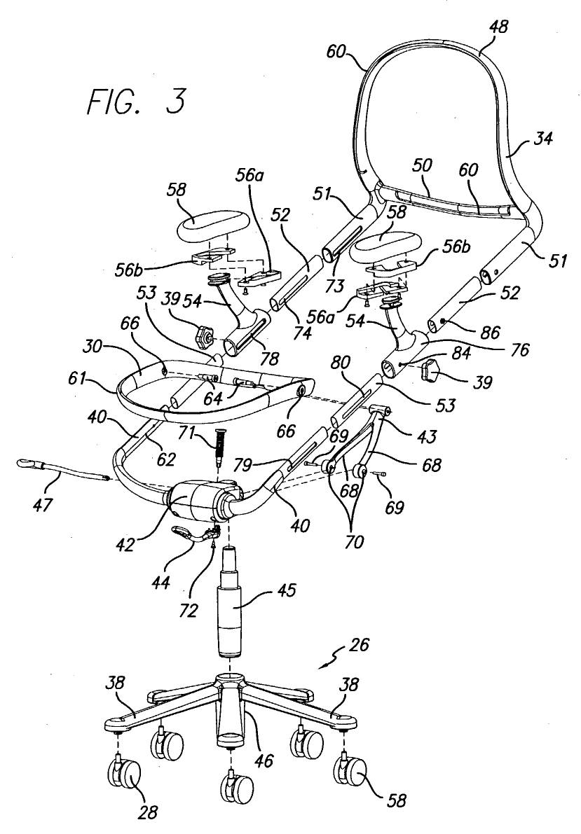

FIG. 3 is an exploded view of the components of the chair. As shown, the back support frame 34 has an upper arch-shaped portion 48 with a cross-member 50 near the bottom of the back support frame. The back support frame also includes a pair of hollow tubular extensions 51, one on each side of the back support frame protruding in a generally forward direction from below the cross-member. The back support extensions interconnect with the arm rests 24 and the front links 40, in a manner allowing adjustment of the depth of the seat and the heights of the back support and the arm rests, as will be described in greater detail. In the preferred embodiment, the back support frame may be injection molded of a rigid plastic material such as nylon, and the front links 40 may be made of steel. Each hollow tubular extension 51 of the back support frame may receive a metal insert sleeve 52 for structural support, and a plastic sleeve 53 may be received over each front link 40 for a better interconnecting fit when the plastic sleeve is received in the metal insert sleeve, as described below. Alternatively, the back support frame and the front links may be formed of die cast aluminum or other material not requiring such sleeves.

The arm rests 24 each include an arm yoke 54 having a generally inverted T-shape and an arm rest pad member comprising first and second adjustment glide members 56a-b and an arm pad 58. These components (together with a plate, omitted in FIG. 3 for clarity) combine in a manner allowing the position of the arm rests to be adjusted in both the fore-and-aft and the sideways directions relative to the seat 20 and the back support 22, as will also be described in greater detail.

The upper arch-shaped portion 48 and the cross-member 50 of the back support frame 34 have channels 60 formed therein extending almost entirely around their periphery to allow the back support member 36 (not shown in FIG. 3) to be attached to the back support frame in known manner. Similarly, the seat frame 30 may have a channel 61 formed therein for mounting the seat member 32 (also not shown in FIG. 3) in known manner. Alternatively, both the back support member and the seat support member may be mounted to their respective frames by any other means conventional in the art. Both the back support member and the seat support member may comprise an elastomeric, woven suspension material sold by Quantum Group Inc. of Colfax, N.C. U.S.A., or a solid plastic material with or without ventilation openings, or any other suitable material. In the alternative, the back support frame and the back support member, or the seat frame and seat member, or both, may be formed as a unitary structure wherein the frame is integral with the member.

Each of the front links 40 is formed in a modified “L” shape. As noted, the front links have forward ends operatively coupled to the tilt control mechanism on opposite sides of the tilt control housing unit 42. On the inside surface of each front link at or near its rearward end, there is formed an internally-threaded hole 62 for pivotally connecting the front links to opposite sides of the seat frame 30 via screws 64 that are inserted through threaded holes 66 in the seat frame.

The tail link 43 is formed preferably of die cast aluminum and has the shape of a wishbone. The tail link includes a pair of arms 68 that are pivotally connected to the rear of the tilt control housing unit 42 via screws 69 through holes 70 in the forward ends of the tail link arms. The second or rear end of the tail link is pivotally connected to the rear of the seat frame 30 via a pin arrangement (see FIG. 2) or other suitable means known in the art.

As can be seen in FIG. 3, a lead screw 71 is received through an opening in the upper surface of the tilt control housing unit 42, and the other end of the lead screw extends through an opening (not shown) in the underside of the tilt control housing unit, where it connects via a screw 72 to a ratchet mechanism at the inner end of the tilt control crank arm 44. Both the tilt control mechanism in the tilt control housing unit and the ratchet mechanism for adjusting the tilt of the chair are described in detail below.

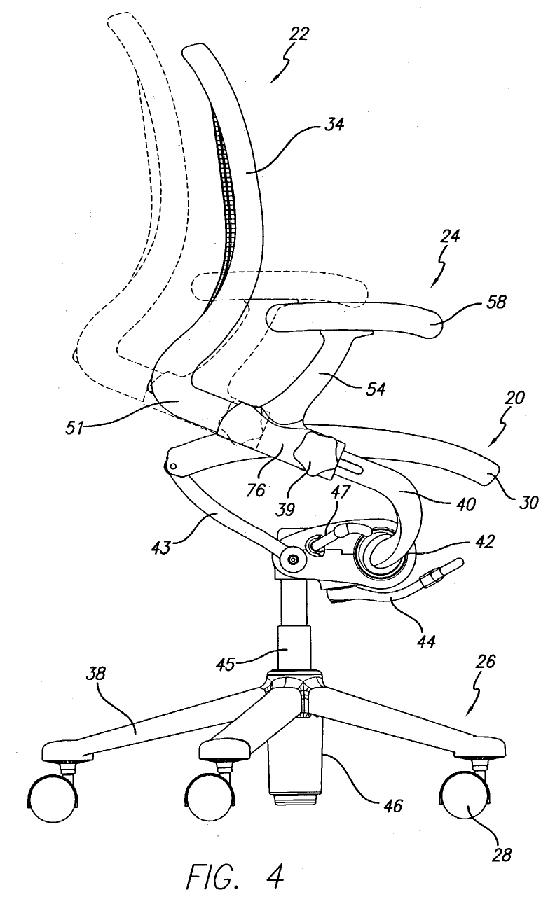

A detailed description of the mechanism by which the depth of the seat 20 and the heights of the back support 22 and the arms rests 24 can be adjusted will now be provided with reference to FIGS. 3-4. As shown in FIG. 3, the back support extensions 51 and their insert sleeves 52, the arm yokes 54, and the second, rearward end portions of the front links 40 and their sleeves 53 preferably are all provided with adjustment recesses and slots, respectively, that allow the position of the back support and arm rests to be adjusted relative to the seat. Specifically, in the preferred embodiment, each of the two hollow tubular back support extensions and their insert sleeves has an adjustment slot 73 and 74, respectively, formed in an inside surface, near the forward end thereof. These slots align when the insert sleeves are inserted into the back support extensions. The base portion 76 of each arm yoke 54 has a hollow, tubular construction with an adjustment slot 78 formed in its inside surface, along substantially the entire length of the base portion. Similarly, each of the front links has an adjustment recess 79, and each of their sleeves has a corresponding adjustment slot 80, formed in their outside surfaces, near their second ends. The adjustment slots in the sleeves align with the adjustment recesses in the front links when the sleeves are received over the front links.

To enable assembly of the back support 22, the arm rests 24 and the seat 20, the second end portion of each front link 40 is sized to slide into a sleeve 53, which is sized to slide into the insert sleeve 52 of each back support extension 51, and each back support extension, in turn, is sized to slide into the base portion 76 of an arm yoke 54. When these components are assembled together, the adjustment slots 73, 74 and 78 on the inside surfaces of the back support extensions, their insert sleeves and the base portions of the arm yokes, respectively, are aligned with each other and with the screws 64 that secure the front links to the seat frame 30. This allows the back support extension and the base portion of the yoke to slide relative to the screws when the position of the back support and the arm rests is being adjusted relative to the seat.

The adjustment knobs 39, which are provided to control the adjustment of the back support 22 and the arm rest 24 relative to the seat 20, each includes a threaded stud. This threaded stud is received through a hole 84 in the outside surface of the base portion of each arm yoke 54, is threaded through a welded threaded fastener 86 in each back support extension 51, is received through the adjustment slot 80 in the outside surface of the sleeve 53 of each front link 40, and then is received into the adjustment recess 79 formed in the outside surface of each front link on each side of the chair. To allow tightening of the adjustment knobs and to prevent them from slipping, a self-adhesive stop pad 88 preferably is installed in the adjustment recess of each front link to serve as a stop for the ends of the threaded studs of the adjustment knobs. One of the adjustment knobs is preferably reverse-threaded so that the knobs turn in the same direction relative to the front of the chair. The knobs may be injection molded out of a plastic material.

As shown in FIG. 4, when the adjustment knobs 39 are loosened, the back support extensions 51 and the arm yokes 54 may be slid along the front links 40 for repositioning the back support 22 and the arm rests 24 as a unit relative to the seat 20. It should be noted that the front links, the base portions 76 of the arm yokes and the back support extensions are all oriented at an oblique angle that is upwardly sloping from front to rear, so that as the back support and arm rests are adjusted in the rearward direction, they are also adjusted upwardly relative to the seat. Conversely, when the back support and arm rests are adjusted in the forward direction, they also are adjusted downwardly relative to the seat. In effect, one movement results in adjustment of both the depth of the seat and the heights of the back support and the arms rests. In the preferred embodiment, this angle is approximately 21° from the horizontal, which means that changes in seat depth and back support-arm rests height occur in the ratio of about 2.5 to 1.

In FIG. 4, the back support 22 and the arm rests 24 are shown in solid lines in their forward-most adjustment position, and the phantom lines show the back support and the arm rests in their rearward-most adjustment position. The forward-most adjustment position minimizes the seat depth and the heights of the back support and the arm rests for use by a smaller person, and the rearward-most adjustment position maximizes the seat depth and the heights of the back support and the arm rests for use by a larger person. The back support and the arm rests are continuously adjustable into any desired position between these minimum and maximum positions. The range of adjustment is controlled by the length of the adjustment slots and recesses in the back support extensions 51 and their insert sleeves 52, the base portions 76 of the arm yokes 54, and the second end portions of the front links 40 and their sleeves 53. In the preferred embodiment the length of these slots and recesses, and hence the range of adjustment, is about 4 inches (about 10 cm.), though it is understood that alternate embodiments are possible having a larger or smaller range of adjustment.

Alternatively, the back support extensions 51, the base portions 76 of the arm yokes 54 and the front links 40 do not need to be tubular or have a rounded cross-sectional shape, but may be formed, for example, as rectilinear channels that interlock so as to be slidable relative to one another. Also, these components need not interlock, but alternatively may simply overlap and be held together by appropriate fastening members that can be loosened or released to allow repositioning of the components relative to one another. Moreover, instead of having the capability of continuous adjustment of the position of the back support relative to the seat, the back support may have a limited number of positions in which it may be releasably locked, spaced apart at selected intervals relative to the seat. By way of example and not limitation, in lieu of the arrangement with adjustment slots and recesses and knobs described above, the front links may be provided with locking members in the form of spring-loaded detents in their outside surfaces that may be adapted to be received in one of a series of spaced-apart adjustment holes formed in the outside surfaces of the back support extensions and their insert sleeves and/or the base portions of the arm yokes. Moreover, the back support 22 and the arm rests 24 need not move as a unit during adjustment. For example, each arm rest be adjustable substantially independent of the back support by having a series of spaced-apart adjustment holes, or an elongated adjustment slot in the base portion of the arm yoke, in lieu of a single hole 84 for the adjustment knob 39.

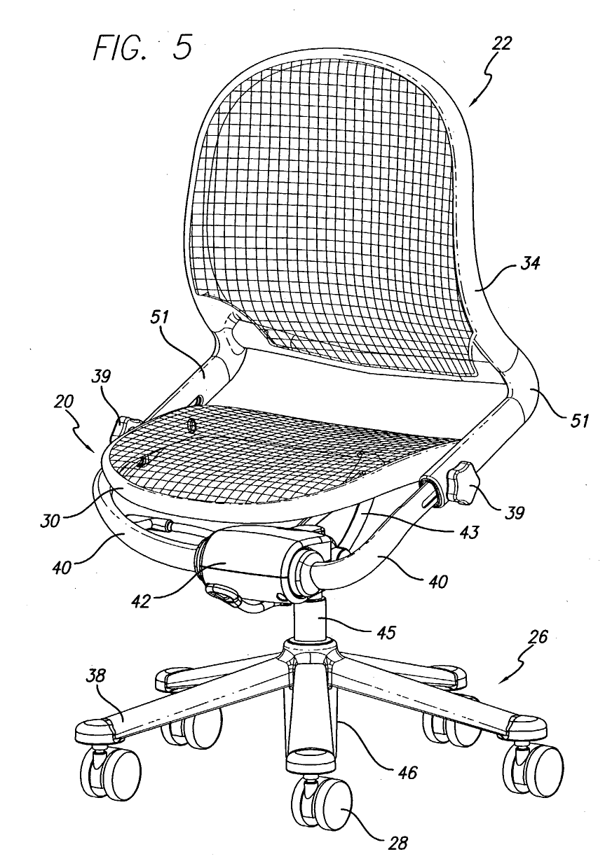

FIG. 5 illustrates an alternative embodiment in which the arm rests 24 have been removed from the chair of FIGS. 1-4. Referring again to FIG. 3, to remove the arm rests, the adjustment knobs 39 are loosened and removed from the fasteners 86 in the insert sleeves 52 of the back support extensions 51. The base portions 76 of the arm yokes 54 and the back support extensions and their insert sleeves are then separated from the second end portions of the front links 40 and their sleeves 53 and from each other. The second end portions of the front links and their sleeves are then re-inserted in the back support extensions without the arm rests, and the adjustment knobs are then re-threaded into the fasteners in the insert sleeves of the back support extensions, through the adjustment slots 80 in the sleeves of the front links, and into the adjustment recesses 79 in the front links, where they are re-tightened against the stop pads 88. The seat depth and the back support height are continuously adjustable in this alternative embodiment in the same manner as described above with respect to FIGS. 1-4.

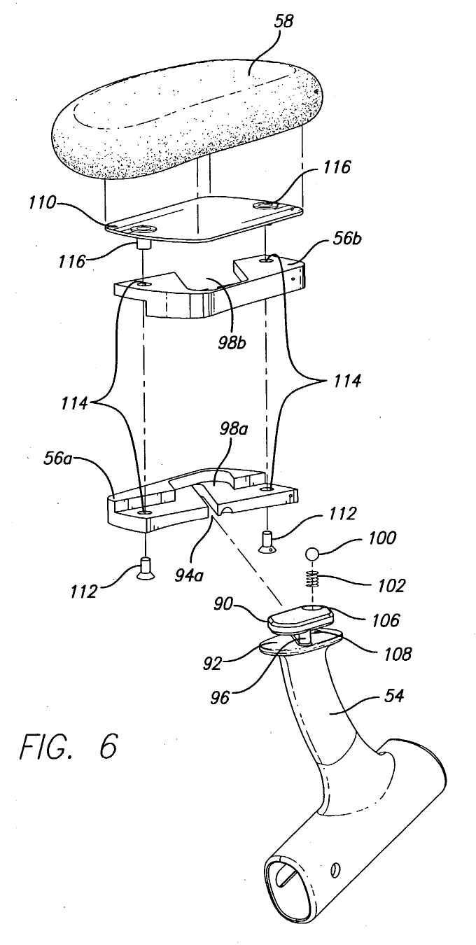

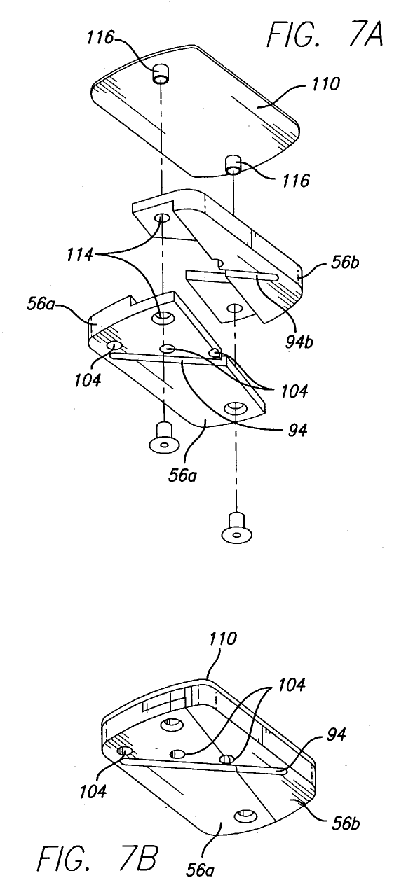

A detailed description of the structure and operation of the adjustable arm rests 24 will now be provided with reference to FIGS. 3, 6 and 7A-B. As noted above, each arm yoke 54 has a generally inverted T-shape. In order to interconnect each arm pad member comprising an arm rest pad 58 and pair of adjustment glides 56a-b with an arm yoke, a raised head 90 is formed on an end surface 92 of each arm yoke, at the top of the substantially vertical portion of the inverted “T” (FIG. 6). Each pair of adjustment glides, when combined together, forms a channel 94 (FIG. 7B) for engaging the head on each arm yoke in a manner that allows the arm pad member to slide relative to the arm yoke.

FIG. 6 shows an exploded view of the adjustable arm assembly from the left side of the chair, while FIGS. 7A-B provide a more detailed illustration of the first and second adjustment glides 56a-b. As shown in FIG. 6, the head 90 at the top of each arm yoke 54 has a generally rectangular shape with rounded edges and corners and a generally flat upper surface. Each head is supported in a raised position above the end surface 92 of the arm yoke by a neck 96. The neck is a relatively narrow, elongated structure that when viewed on end has a width allowing it to be received with a clearance fit for sliding in the channel 94 formed by the combined adjustment glides, and when viewed from the side has substantially the same extent as the head it supports. The height of the neck is such that, when received in the channel, it provides clearance between the bottom surface of each head and the top surface of the combined adjustment glides.

FIGS. 6 and 7A-B illustrate how the first and second adjustment glides 56a-b are joined together to capture the neck 96 at the top of the arm yoke 54 in the channel 94 and allow the assembled arm pad member to slide relative to the arm yoke. As shown in FIGS. 6 and 7A, the first adjustment glide 56a and the second adjustment glide 56b have channel portions or slots 94a and 94b, respectively, formed therein. The two adjustment glides are configured so that their combination results in a lap joint, and when they are combined their slots align to form the complete channel that receives the neck. The width of the slots, and therefore of the resulting channel, is slightly greater than the width of the neck to provide the clearance fit noted above and allow sliding movement of the neck in the channel.

Each adjustment glide 56a-b also has an enlarged recess portion 98a-b formed in its upper surface surrounding its slot 94a-b, respectively. When the two adjustment glides are combined, these recess portions similarly align to form a complete recess to receive the raised head 90 on top of the arm yoke 54. This recess has sufficient depth and breadth for the head, while allowing the neck to travel substantially the full length of the channel 94 when the position of the arm pad member is being adjusted. In the preferred embodiment, each channel has a length of about 3.5 inches (about 9 cm.).

In the preferred embodiment, each arm yoke 54 is fitted with a locking member in the form of detent mechanism comprising a ball bearing 100 and associated spring 102 (FIG. 6), or other similar device, to releasably lock the arm pad in any one of several adjustment positions relative to the seat 20 and back support 22. This detent mechanism can selectively engage one of several spaced-apart locking recesses 104 formed in the bottom surface of the first adjustment glide 56a (FIGS. 7A-B) as described below.

To assemble the adjustable arm rests 24, the spring 102 and ball bearing 100 are first inserted through a bore 106 formed as a pass-through in the head on top of each arm yoke 54 and into a recess 108 in the end surface 92 of each arm yoke. The depth of this recess is such that the upper portion of the ball bearing protrudes above the end surface due to the bias of the spring. The first adjustment glide 56a is then installed by sliding it so that the neck 96 of the arm yoke is received in the slot 94a and the head 90 of the arm yoke is received in the recess portion 98a of the first adjustment glide. This captures the ball bearing-and-spring detent mechanism between the bottom surface of the first adjustment glide and the end of the arm yoke.

The second adjustment glide 56b may then be slid into position from the opposite side so that the neck 96 is received into its slot 94b and the head 90 is received into its recess portion 98b, with the two adjustment guides forming their lap joint. A plate 110 is then positioned on top of the combined adjustment glides, and the adjustment glides are joined together with the plate by a pair of fasteners such as screws 112 inserted through holes 114 formed in the adjustment glides and threaded into T-nuts 116 received in holes in the plate from the opposite side. The plate serves to strengthen and stiffen the adjustment glide assembly and to capture the head in the recess formed by combining the adjustment glides around the neck.

Each arm pad 58 is then mounted on a corresponding plate-and-adjustment glides assemblage to complete the arm pad member. In this regard, each arm pad has a recess formed in its bottom surface (not shown) which allows the arm pad to be received over and substantially conceal the plate-and-adjustment glides assemblage. The arm pad can be attached in any conventional manner, such as by forming the arm pad recess with an undercut so that is received over the assemblage with a snap-like fit, or by using an adhesive, or by being molded directly onto and around the plate.

Preferably, the arm yokes 54 are injection molded of a plastic material such as nylon, the adjustment glides 56a-b are made from nylon, and the plate 110 is made of a metal such as steel. The arm pads 58 preferably are formed of a pliant but durable material such as polyurethane foam, and they are configured to comfortably support a user's arms. Alternatively, the arm pads may be injection molded of a plastic that has sufficient rigidity and strength to eliminate the plate, yet also provides adequate comfort for the user.

It should be noted that, as shown in FIGS. 3, 6 and 7A-B, the channels 94 formed by the combined adjustment glides 56a-b form an oblique angle directed outwardly from back to front. The neck 96 of each arm yoke 54 similarly is oriented at substantially the same angle. As a result, when the user slides the plate-and-adjustment glides assemblage to adjust the positions of the arm pads, the arm pads move forward-and-outward or rearward-and-inward, as the case may be, in this angular direction. In this manner, the arm pad adjustments accommodate differing body heights and widths of larger and smaller users with one movement of the arm pads. In the preferred embodiment, the angle of each channel in the combined adjustment glides and of each neck on the arm yokes is about 45°. As a result, any movement of the arm pads results in approximately equal adjustment in both the fore-and-aft and sideways directions.

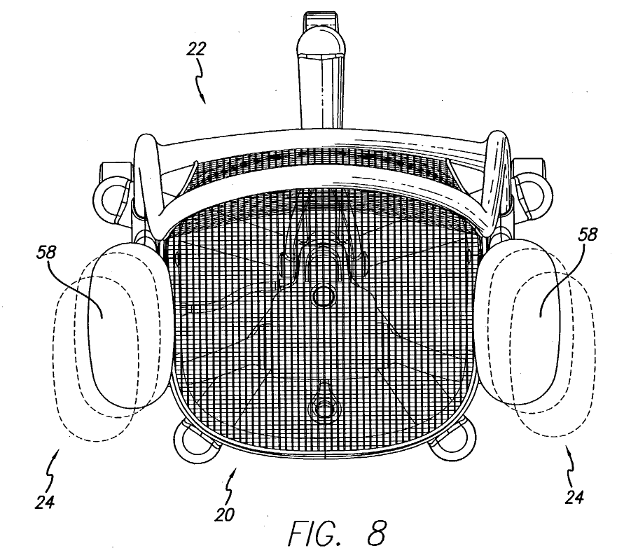

FIG. 8 illustrates the positioning of the arm pads 58 as they are adjusted between three different positions. Each arm pad may be moved in either direction until its spring-loaded ball bearing 100 engages a locking recess 104 on the bottom surface of the first adjustment glide 56a. Such engagement serves to releasably lock the arm pad in place. Continued adjustment requires the user to apply sufficient force to the arm pad to dislodge the ball bearing from its locking recess. This may be repeated for each arm rest until a comfortable position for both arm pads is reached or until no further movement is possible. It is understood that although FIG. 8 only shows three different positions for the arm pads (one in solid lines and two in phantom lines), the first adjustment glides may be equipped with several additional positioning recesses (not shown) on their bottom surfaces in order to allow the arm pads to be adjusted further inward or outward in smaller or larger increments. Alternatively, other releasable locking mechanisms may be employed that allow continuous adjustment and locking of the arm pads in any position.

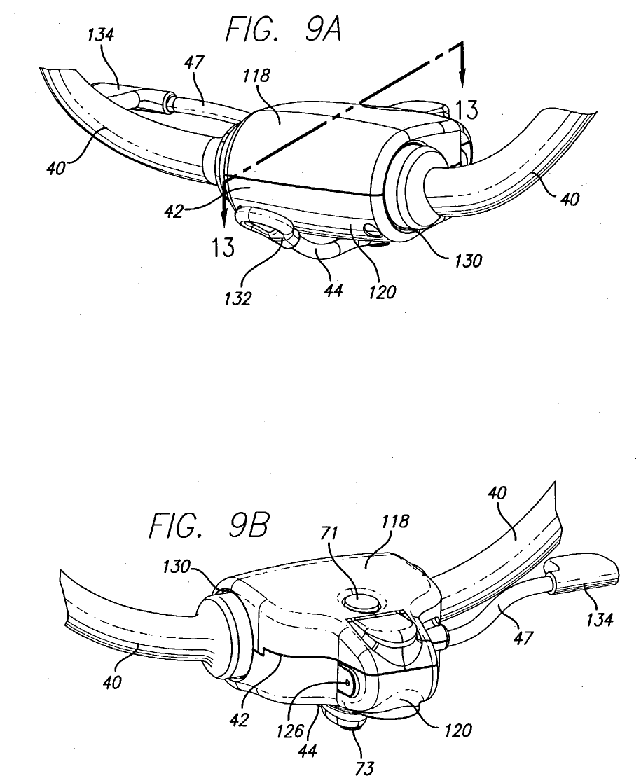

A description of the tilt control mechanism within the tilt control housing unit 42 will now be provided with reference to FIGS. 9A-B through 15. The details of the tilt control mechanism design within the tilt control housing unit 42 are conventional and form no part of the invention.

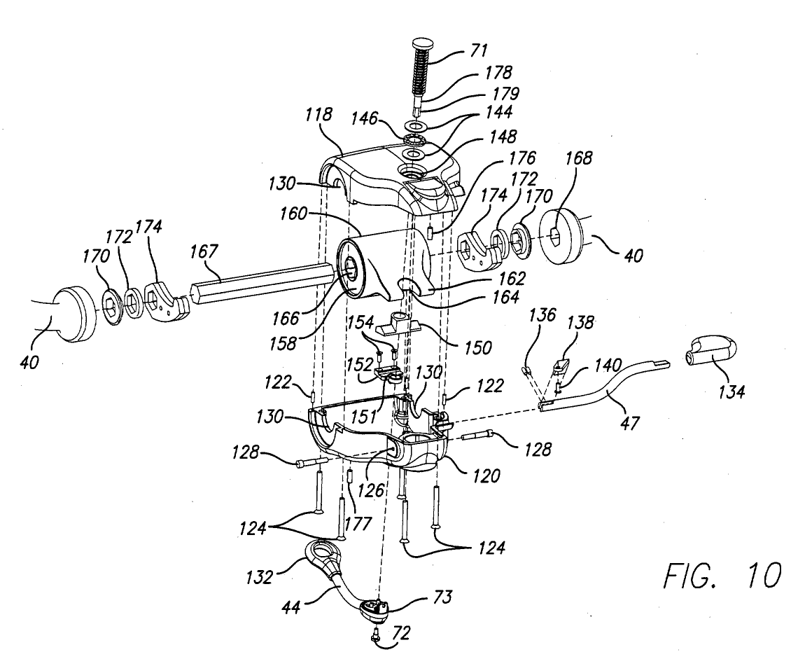

As shown in FIGS. 9A-B, the tilt control housing unit 42 includes top and bottom casing shells 118 and 120, respectively, preferably formed of die cast aluminum. The two shells are held together by steel alignment pins 122 at their corners and several coupling screws 124 that extend through the bottom casing shell and into the top casing shell (FIG. 10). The bottom casing shell is configured with threaded holes 126 located on opposite sides at the rear of the tilt control housing unit for pivotally connecting the tail link 43 via shoulder screws 128 (FIGS. 9B and 10). As best seen in FIG. 10, the forward ends of the front links 40 are enlarged to fit within recesses surrounding openings 130 that are formed in the sides of the tilt adjustment housing unit when the top and bottom casing shells are joined together. The tilt control crank arm 44 extends forward from the bottom of the tilt control housing unit and includes a knob 132; the pneumatic lever arm 47 extends laterally from the right side of the tilt control housing unit and also includes a knob 134. The inner end of the pneumatic lever arm is joined by two set screws 136 and includes a steel pin activator 138 and an adjustment screw 140 for coupling the inner end of the pneumatic lever arm to the actuator (not shown) of the pneumatic mechanism.

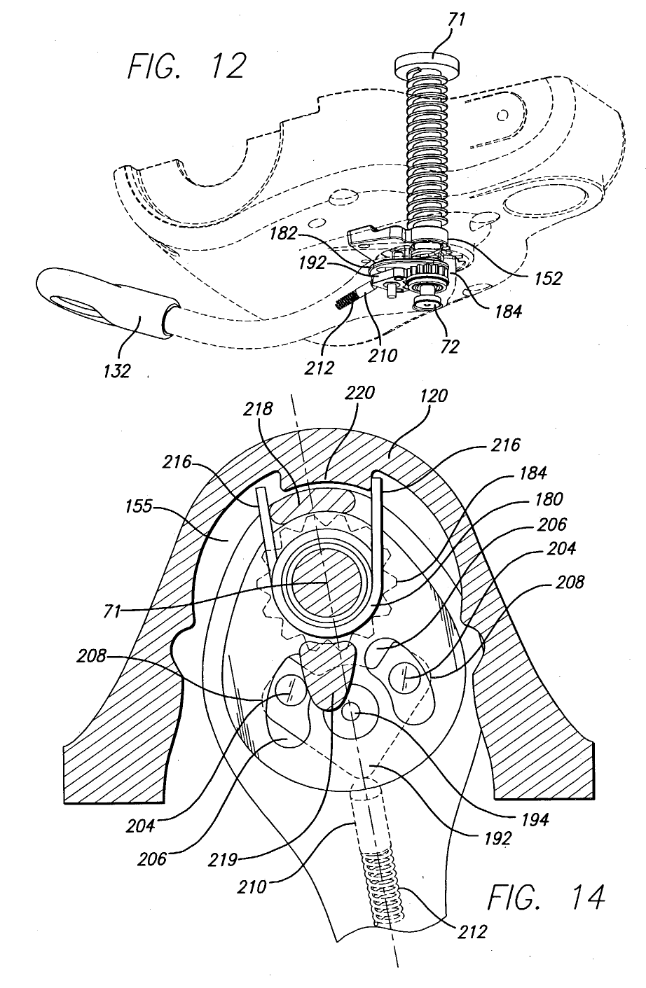

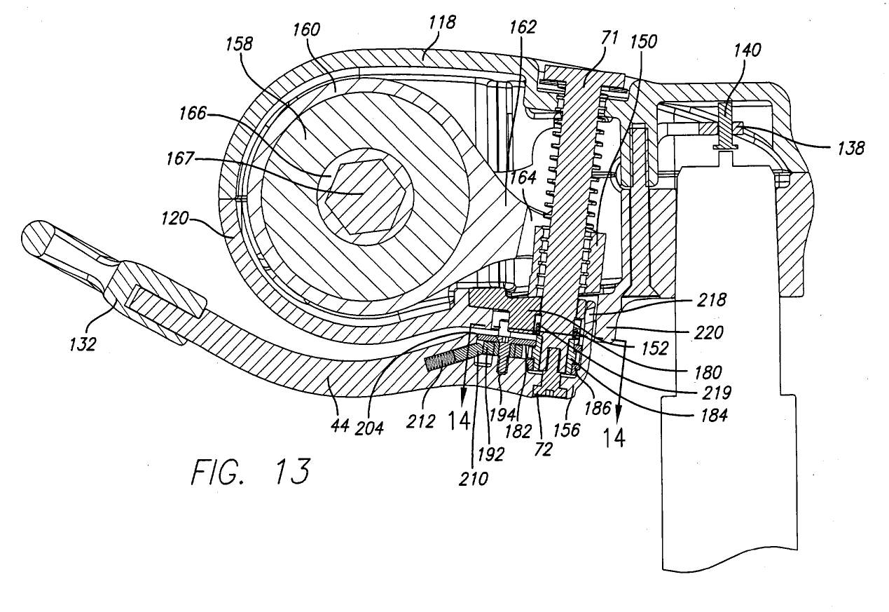

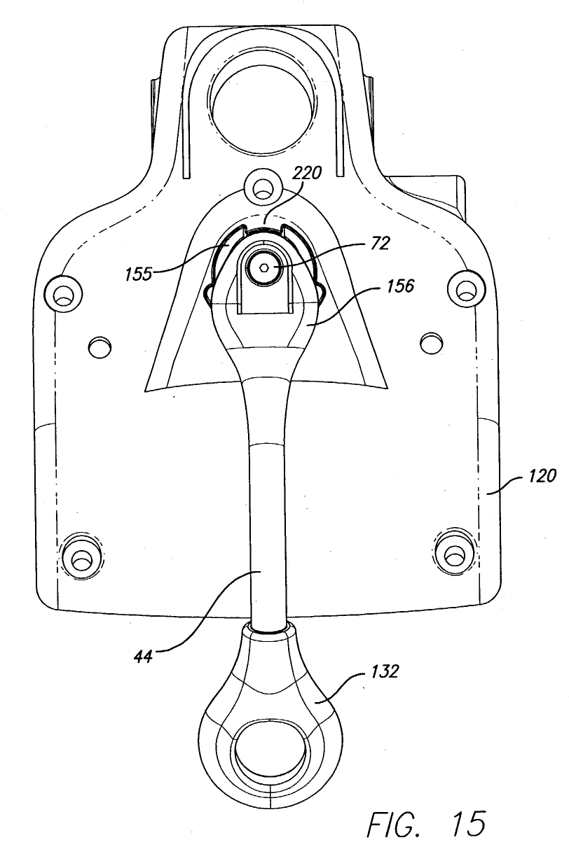

The lead screw 71 is positioned through an opening 148 in the upper surface of the top casing shell 118, surrounded by appropriate washers 144 and a ball bearing ring 146 so that the lead screw can be rotated within the tilt control housing unit. The lead screw engages a lead screw nut 150 and extends through an opening 151 in a cam plate 152, which is secured by screws 154 on the inside bottom wall of the tilt control housing unit. The lead screw then extends through an opening 155 (see FIGS. 14-15) in the underside of the bottom casing shell 120, where it connects via screw 72 to a ratchet mechanism contained within a ratchet housing 156 on the inner end of the tilt control crank arm 44 (see FIGS. 10, 12 and 13).

The tilt control housing unit 42 includes a cylindrically-shaped rubber torsion spring 158, which is housed within a metal spring shell 160. The spring shell has a laterally-protruding extension flap 162 that is provided with a cradle 164 in which the lead screw nut 150 is held against rotation. The rubber torsion spring has a metal insert sleeve 166 with a hexagonal-shaped bore through its center. A steel bar 167 with a complementary hexagonal shape is received through the bore in the insert sleeve of the rubber torsion spring, and the ends of the hexagonal bar extend through the openings 130 in the sides of the tilt control housing unit 42, where hexagonal bar mates with complementary hexagonal-shaped recesses 168 formed in the forward enlarged ends of the front links 40. The hexagonal bar thus operatively couples the rubber torsion spring to the front links. A mated bushing 170 and spacer 172, both preferably formed of nylon, and a welded stamp-sealed stop plate 174 are positioned on the hexagonal bar on opposite sides of the rubber torsion spring. The stop plates lock the rubber torsion spring in place and limit the maximum torsional movement of the rubber torsion spring and hexagonal bar within the tilt control housing unit.

In operation, it is the torsional action of the rubber torsion spring 158 within the spring shell 160 that allows the chair to tilt, and it is the amount of torsional loading applied by the lead screw nut 150 to the extension flap 162 of the spring shell that determines the rubber torsion spring's stiffness or resistance to tilting. In this regard, the tilt control crank arm 44 can be cranked from a center position to one side in order to turn the lead screw 71 in a clockwise direction, and from the center position to the other side to turn the lead screw in a counter-clockwise direction. A self-switching mechanism in the ratchet housing 156, described below, allows the tilt control crank arm to engage the lead screw when the crank arm is pivoted to the side, and to release the lead screw when the crank arm pivots back to the center. As the lead screw is turned by the crank arm, this causes the lead screw nut to increase or decrease application of force on the extension flap, and hence on the rubber torsion spring, depending on the direction of rotation of the lead screw. A forward tilt adjustment set screw 176 and a rearward tilt adjustment set screw 177 are provided in the tilt control housing unit to limit the range of torsional movement of the extension flap on the spring shell. This, in turn, limits the torsional movement of the hexagonal bar and, hence, the range of pivotal movement of the front links 40.

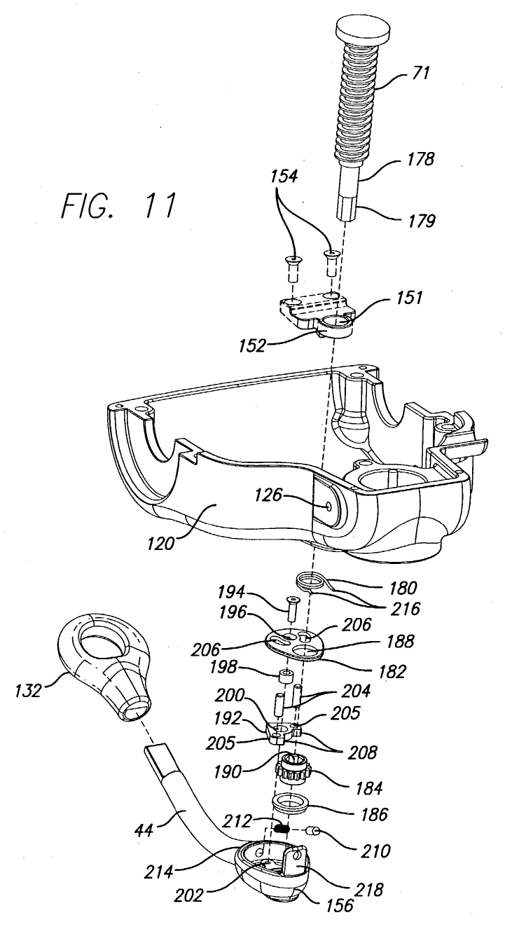

FIGS. 11-13 illustrate the ratchet mechanism in the ratchet housing 156 on the inner end of the tilt control crank arm 44 for the tilt control housing unit 42. Except for the self-centering aspect of the crank arm to be described, the ratchet mechanism is conventional and forms no part of the invention.

As previously discussed, and as shown in FIG. 11, the end of the lead screw 71 extends through the opening 151 in the cam plate 152 at the bottom of the tilt control housing unit and then through the opening 155 in the underside of the tilt control housing unit. Below its threaded, the lead screw portion has a smooth circular shaft portion 178 followed by an hexagonal-shaped end portion 179. The lead screw then extends through a spring-wire torsion spring 180 so that the spring is disposed on the circular shaft portion of the lead screw, just above its hexagonal shaped end portion. The lead screw then further extends through an assemblage of a parabolic cam 182, a ratchet gear 184 and a bushing 186. The ratchet gear has a collar above its gear teeth that fits through an opening 188 in the parabolic cam, and the ratchet gear has a similar collar below its gear teeth that fits through the bushing. The hexagonal-shaped end of the lead screw is received through a complementary hexagonal-shaped bore 190 through the ratchet gear to couple them together.

A generally heart-shaped pawl 192 also is mounted within the ratchet housing for pivotal movement beneath the cam 182, proximate the ratchet gear 184. The cam and pawl are held in place by a screw 194 that extends through an opening 196 in the cam and a bushing 198 that is inserted in an opening 200 in the pawl, and is then received in a threaded hole 202 in the ratchet housing. The pawl 192 has a pair of follower pins 204 that are inserted in holes 205 in the surface of the pawl and extend through a corresponding pair of cam grooves 206 formed in the parabolic cam 182. The side of the pawl facing the ratchet gear (i.e., the top of its heart shape) has a pair of opposing tongues 208, one of which engages the teeth on the ratchet gear 184 during pivoting of the tilt crank control arm 44, depending on the state of the pawl switch.

A biasing pin 210 with a rounded end and a spring 212 are received in a recess 214 formed in a sidewall of the ratchet housing 156, adjacent the other side of the pawl (i.e., the bottom of its heart shape). The spring-loaded biasing pin 210 contacts the edge of the pawl on this side, opposite the tongues, and serves to bias one or the other of the pawl tongues into engagement with the ratchet gear. The spring-wire torsion spring 180 has two wire legs 216, and the ratchet housing 156 has an upwardly-extending member 218 that is received between these wire legs.

When the tilt control crank arm 180 with its assembled ratchet mechanism is installed in place on the underside of the tilt control housing unit 42, the upper ends of the follower pins 204 extend above the top of the cam 182 and are disposed proximate a pawl-switch actuator 219. The pawl-switch actuator is in the form of a rounded projection that extends downward from the bottom of the cam plate 152 within the tilt control housing unit 42 (FIG. 13). The free ends of the wire legs 216 of the spring-wire torsion spring 192 extend past the upwardly-extending member 218 on the ratchet housing and are received on either side of a radially-inward projection 220 formed on the periphery of the opening 155 in the underside of the bottom casing shell 120. The width of this projection is substantially the same as the width of the upstanding member on the ratchet housing.

In operation, the user can pivot the tilt control crank arm 44 up to 90° to either side of center, depending on whether clockwise or counter-clockwise rotation of the lead screw is desired. As illustrated in FIG. 14, when the tilt control crank arm is pivoted counter-clockwise to one side of center, for example, the follower pin 204 carried by the pawl 192 on the trailing side (away from the direction of pivoting) contacts and is also driven counter-clockwise by the edge of the pawl-switching actuator 219 to one end of the follower pin's cam groove 206. This, in turn, causes the pawl to pivot counter-clockwise such that the edge of the pawl that is in contact with the spring-loaded pin 210 travels over center relative to the pawl's heart shape. As a result, the spring-loaded pin biases the pawl for further counter-clockwise pivoting, which tends to drive the tongue 208 on the opposite side of the pawl toward the gear teeth on the ratchet gear 184. Continued pivoting of the tilt control crank arm results in the follower pin clearing the pawl-switching actuator as the follower pin reaches the outermost end of its cam groove. About the same time, the tongue on the pawl engages the gear teeth on the ratchet gear. As the tilt control crank arm is further pivoted up to 90°, the engagement between the pawl tongue and the gear teeth on the ratchet gear causes the lead screw 71 to rotate in the counter-clockwise direction.

As the lead screw 71 is rotated by pivoting the tilt control crank arm 44 in the counter-clockwise direction in the example above, the side edge portions of the upwardly-extending member 218 of the ratchet housing 156 engage and push the wire leg 216 of the spring-wire torsion spring 180 on the lead side of the pivoting motion. At the same time, the projection 220 on the periphery of the opening 155 in the underside of the bottom casing shell 120 acts as a stop to prevent the other spring wire from following, so that the spring-wire torsion spring becomes torsionally loaded as the crank arm is pivoted. When the user has completed pivoting the tilt control crank arm up to 90°, the torsional load in the spring-wire torsion spring automatically tends to return the tilt control crank arm to the center position, i.e., rendering the crank arm self centering. When this happens, the cam 182 pivots with the tilt control crank arm on its return trip, which in turn drives the other follower pin 204 in its cam groove 206 in the same direction and causes the tongue 208 on the pawl 202 to disengage the ratchet gear. The tilt control crank arm 44 can be repetitively pivoted to the same side and back to the center position to further rotate the lead screw in the counter-clockwise direction.

For rotation of the lead screw 71 in the clockwise direction, the above description is simply reversed. Significantly, as the tilt control crank arm 44 is pivoted from the center position in the clockwise direction, the pawl-switch actuator 219 automatically acts on the other follower pin 204 to switch the orientation of the pawl 192 so that the other tongue 208 engages the ratchet gear 184 and rotates the lead screw in the clockwise direction, i.e., rendering the ratchet mechanism self switching. Alternatively, a conventional clutch mechanism could be used.

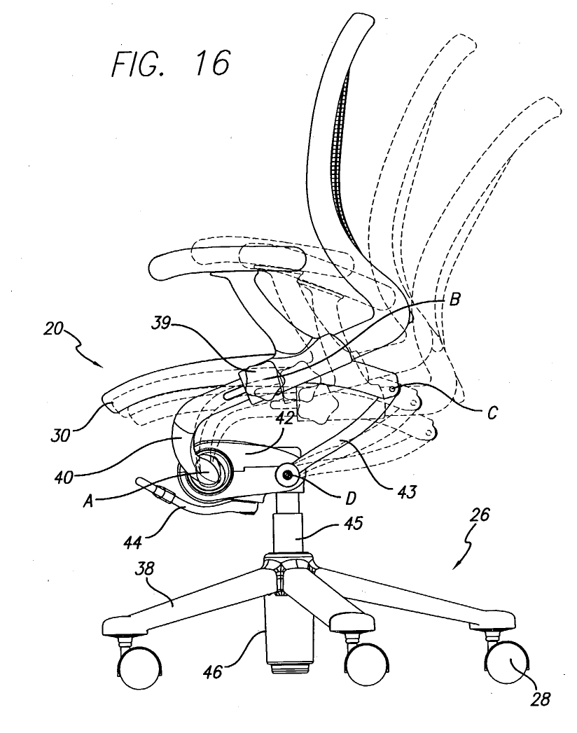

FIG. 16 illustrates how the chair of the present invention provides for controlled tilting of the back support and the seat about several pivot points. A first pivot point A is formed where the forward ends of the front links 40 operatively interconnect with the tilt control mechanism contained in the tilt control housing unit 42 on opposite sides thereof. A second pivot point B is formed where the second or rear end portions of the front links are pivotally connected by screws 64 on opposite sides of the seat frame 30 (FIG. 3). A third pivot point C is formed where the second or rear end of the tail link 43 is connected to the rear of the seat frame 30. And, a fourth pivot point D is formed where the arms 68 at the forward end of the tail link are connected to the rear of the tilt control housing unit.

As described above, the tilt control crank arm 44 allows the user to control the stiffness with which the front links pivot at the first pivot point A under control of the tilt control mechanism. The other end of the front links at the second pivot point B, and both ends of the tail link at the third and fourth pivot points C and D are freely pivotal, but they are subject to the control of the tilt control crank arm by reason of their interconnection with the first pivot point A through the tilt control housing unit, the front links, the seat frame and the tail link. Alternatively, the tilt control mechanism may be located at one of the other pivot points, such as pivot point D.

When the tilt control housing unit 42 has been set by operation of the tilt control crank arm 44 to allow tilting with appropriate stiffness or spring resistance, the user can tilt the chair backwards in the usual manner by leaning against the back support 22 and pushing against the floor with his or her feet while sitting normally in the seat 20. In response, the first pivot point A allows the back support to tilt backward. The seat also tilts backward, but to a lesser degree as compared to the back support.

FIG. 16 shows the back support and seat before tilting in solid lines, and two tilted positions in phantom lines. As can be seen, the back support tilts to a relatively high degree, whereas the rear of the seat tilts to a smaller degree, with the height of the front of the seat decreasing somewhat as the seat tilts backward. This is because the pivoting elements of the chair approximate a parallelogram, with the front links 40 and the tail link 43 forming one pair of substantially parallel opposing sides, and the seat frame 30 and the tilt control housing unit 42 forming the other pair of substantially parallel opposing sides of the parallelogram. Because side A-D of the parallelogram (defined by pivot points A and D on the tilt control housing) remain substantially parallel to the floor at all times, and because side C-D of the parallelogram (defined by pivot points C and D on the tail link) may be somewhat shorter than side A-B of the parallelogram (defined by pivot points A and B on the front links), the side B-C (defined by pivot points B and C on the seat frame) tilts to a lesser degree than the back support during tilting. As a result, the tilting mechanism of the chair allows the user to tilt the chair backwards without significantly tilting the seat, while the height of the seat actually is lowered somewhat, with the benefit that the user's feet do not have to leave the floor. Similarly, when the user tilts the chair forward, the tilt of the seat changes relatively little compared to the tilt of the back support, while the height of the seat raises somewhat to maintain the user in a comfortable position. The degree to which the seat tilts relative to the back support can be changed by varying the spatial relationships between the support frame members and the four pivot points.

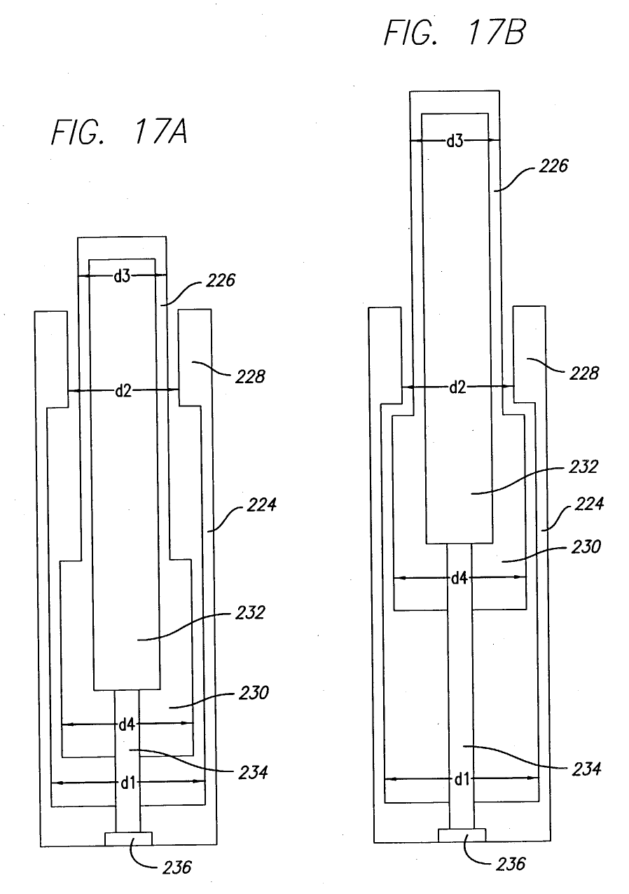

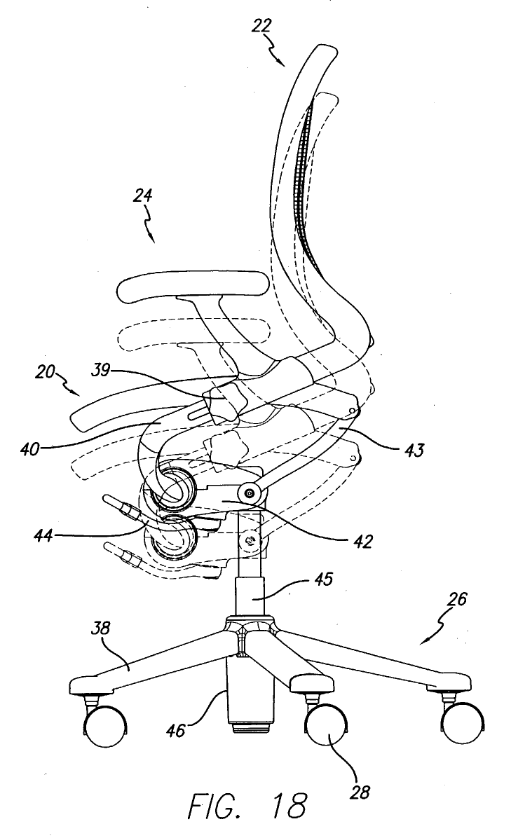

As noted, the seat of the adjustable chair of the present invention is preferably height-adjustable. As best seen in FIG. 17, the height control housing unit 46 extends from the top of the support base 26 downwardly between the legs 38. As previously noted, the height control housing unit contains the pneumatic mechanism 45 that is controlled by the pneumatic lever arm 47 (not shown) to raise and lower the height of the seat 20. Preferably, the pneumatic mechanism comprises at least two telescoping sections and is spring-loaded such that the telescoping sections expand and contract, as desired, when activated by the pneumatic lever arm.

FIG. 17A schematically illustrates a cross-sectional view of the component parts of the pneumatic mechanism 45 in the height control housing unit 46 (not shown) in a lowered position, while FIG. 17B schematically illustrates a cross-sectional view of the component parts of the pneumatic mechanism in a raised position. As shown in FIGS. 17A-B, the pneumatic mechanism includes an outer glide tube 224 and an inner telescoping tube 226. The outer glide tube has a first inner diameter d1 and is mounted in the height control housing unit (not shown) in a conventional fashion. The outer glide tube is equipped with an inner rim 228 that surrounds an inner circumference of the outer glide tube and is positioned near a top portion of the outer glide tube, thereby creating a second inner diameter d2 within the outer glide tube, at the top of the outer glide tube, that is smaller than the first inner diameter d1.

The inner telescoping tube 226 has a third outer diameter d3 that is smaller than the first and second inner diameters d1 and d2. The inner telescoping tube is positioned such that it slides within the outer glide tube 224. The top of the inner telescoping tube is mounted to the tilt control housing unit (not shown) in a conventional fashion. In the raised position, the inner telescoping tube is fully extended such that only a lower portion of the inner telescoping tube remains inside the outer glide tube. However, the overlapping sections of the inner telescoping tube and the outer glide tube offset any moments acting on the chair and are able to fully support any user sitting on the chair.

In order to limit the upward travel of the inner telescoping tube 226, it is provided with an outer rim 230 which surrounds an outer circumference of the inner telescoping tube near its bottom, thereby creating a fourth outer diameter d4. This fourth outer diameter d4 is larger than the second inner diameter d2, yet smaller than then first inner diameter d1, thereby allowing the inner telescoping tube to move freely within the outer glide tube. However, when fully extended, the outer rim of the inner telescoping tube engages the inner rim of the outer glide tube, thereby keeping the inner telescoping tube within the outer glide tube.

To adjust the vertical position of the chair, a conventional cylindrically-shaped gas spring 232 is mounted within the height control housing unit. A piston rod 234 extends outwardly from the gas spring in an axial direction when the gas spring is activated. An end 236 of the piston rod is coupled to a bottom wall of the outer glide tube 224 such that when the gas spring is activated by the pneumatic lever arm 47, the piston rod extends outward axially, thereby forcing the gas spring and the inner telescoping tube 226 upward within the outer glide tube and causing the pneumatic mechanism 45 to raise the seat 20 upward from the tilt control housing unit 42.

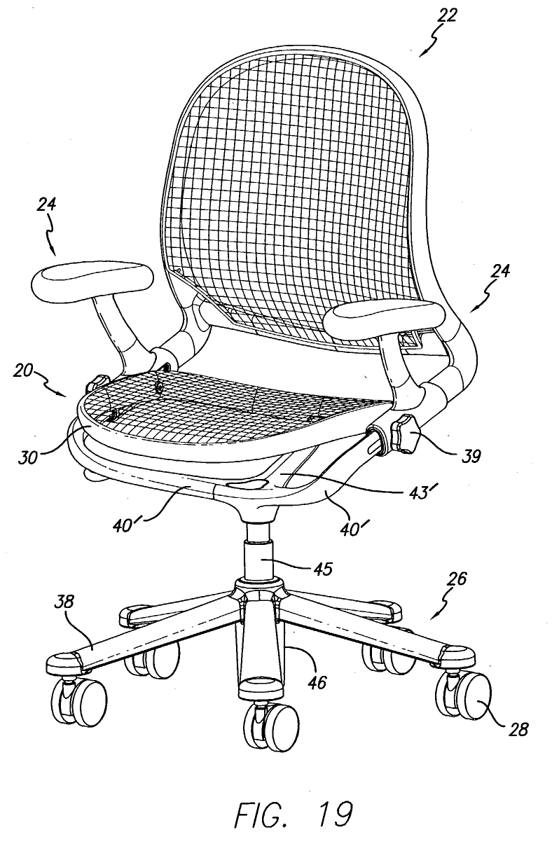

FIG. 18 illustrates how, as the pneumatic mechanism 45 expands or contracts, the seat 20 moves up or down, respectively. The solid lines show the chair with its seat at the maximum height, and the phantom lines show the chair with its seat at the minimum height. In the preferred embodiment, the seat may be height adjustable for younger children in the age range of 6 to 12 years from a minimum of about 12 inches (30 cm.) to a maximum of about 16 inches (41 cm.), thereby allowing the chair to be raised or lowered about 4 inches (10 cm.). The minimum seat height is achieved due to the suspension of the height control housing unit downward from the top of the support base 26, so that substantially the entire height control housing unit is between the legs 38. It can also be seen in FIG. 16 that, when the chair is raised or lowered, the pivot points A-D of the chair do not significantly affect the tilt of the chair.

FIG. 19 illustrates a schematic diagram of an alternative embodiment of the adjustable chair of the present invention. The embodiment illustrated in FIG. 18 is similar to the previously discussed embodiments with the exception that this alternative embodiment does not include a tilt control housing unit, separate front links or a separate tail link. In their place is an integral frame, preferably made of die cast aluminum. The frame includes a pair of support frame members in the form of dual curved, solid tubular front end support bars 40′, disposed on opposite sides of the chair, and a further support frame member in the form of a rear end support bar 43′. The rear end support bar is coupled to the rear of the seat frame 30, preferably using the same pin arrangement (not shown) as discussed in connection with FIG. 2. Preferably the seat is supported on a telescoping pneumatic mechanism 45 in a height control housing unit 46 that directly interconnects the frame with the support base 26. This alternative embodiment has all of the same adjustment features that allow adjustment the depth of the seat, the heights of the back support 22, and the arm rests 24, and the position of the arm rests. The arm rests also are removable as with the other embodiments.

It will be apparent from the foregoing that the present invention satisfies a need for an adjustable desk chair that accommodates a variety of body shapes and sizes for users from children to adults. In particular, the adjustable chair of the invention accommodates changes in the body shapes and sizes of children between young childhood and adulthood, so that the chair may remain useful for several years as the child grows.

The foregoing detailed description of the present invention describes various embodiments and features of an adjustable chair that are provided for the purposes of illustration and are not intended to be exhaustive or to limit the invention to precisely any one of the embodiments disclosed. Accordingly, the scope of the present invention is defined and limited only by the following claims.

What is claimed is:

1. An adjustable chair comprising:
a generally horizontal seat having a front edge, a rear edge and a surface for sitting;
a first support frame member; and
a generally vertical back support movably coupled to said first support frame member, said first support frame member positioning said back support above and proximate said rear edge of said seat, the distance between said front edge of said seat and said back support defining the depth of said sitting surface of said seat,
wherein said back support is selectively movable relative to said first support frame member in the fore and aft direction relative to said seat, foreward movement of said back support increasing the depth of said sitting surface of said seat, and rearward movement of said back support decreasing the depth of said sitting surface of said seat.

2. An adjustable chair as set forth in claim 1, wherein said first support frame member forms a generally oblique angle with said sitting surface of said seat, and further wherein foreward movement of said back support increases both the depth of said sitting surface of said seat and the height of said back support, and rearward movement of said back support decreases both the depth of said sitting surface of said seat and the height of said back support.

3. An adjustable chair as set forth in claim 2, and further including an arm rest connected to said back support, wherein the height of said arm rest increases and decreases with said back support.

4. An adjustable chair as set forth in claim 2, and further including means for releasably locking said back support to said first support frame member in a selected position relative to said seat.

5. An adjustable chair as set forth in claim 4, wherein said releasable locking means includes a locking member carried by at least one of said back support frame and said first support frame member, and a recessed area in at least one of the other of said back support frame and said first support frame member for selectively receiving said locking member.

6. An adjustable chair as set forth in claim 5, wherein said recessed area is elongated and said locking member comprises a threaded adjustment knob, whereby the position of said back support is continuously adjustable relative to said seat over substantially the length of said recessed area.

7. An adjustable chair as set forth in claim 4, wherein said back support and said first support frame member are sized and shaped for interlocking engagement so as to allow said back support to slide relative to said first support frame member.

8. An adjustable chair as set forth in claim 7, and further including an arm rest, said arm rest sized and shaped for interlocking engagement with at least one of said back support and said first support frame member so as to allow sliding movement of said arm rest.

9. An adjustable chair as set forth in claim 8, wherein said arm rest is removable.

10. An adjustable chair as set forth in claim 3, wherein said arm rest comprises:
an arm rest frame member; and
an arm pad member movably coupled to said arm rest frame member,
wherein said arm pad member is selectively movable for adjusting the position of said arm pad member in a generally horizontal plane relative to said seat and said back support.

11. An adjustable chair as set forth in claim 10, wherein said arm pad member is movable in said generally horizontal plane at an oblique angle relative to said side edges of said seat, whereby movement of said arm pad member in one direction results in forward-and-outward adjustment of the position of said arm pad member relative to said seat and said back support, and movement of said arm pad member in an opposite direction results in rearward-and-inward adjustment of the position of said arm pad member relative to said seat and said back support.

12. An adjustable chair as set forth in claim 11, wherein said arm rest frame member and said arm pad member are sized and shaped for interlocking engagement so as to allow said arm pad member to slide relative to said arm rest frame member.

13. An adjustable chair as set forth in claim 11, and further including means for releasably locking said arm pad member to said arm rest frame member in a selected position relative to said seat and said back support.

14. An adjustable chair as set forth in claim 2, and further including:
a support base, said support base including a plurality of radially-outwardly and downwardly extending legs;
a height control adjustment mechanism coupled to and supporting said seat above said support base; and
a height control housing unit for housing said height control adjustment mechanism, said height control housing unit contained substantially entirely within said support base, extending downwardly between said legs.

15. An adjustable chair as set forth in claim 14, wherein the height of said seat is adjustable by said height control adjustment mechanism from a minimum of 12 inches to a maximum of 16 inches.

16. An adjustable chair as set forth in claim 1, and further including:
a base member positioned generally below said seat;
a second support frame member; and
a tilt control mechanism,
wherein said first and second support frame members each have a forward end and a rearward end, one of said ends of each of said first and second support frame member coupled to said seat and the other of said ends of each of said first and second support frame member coupled to said base member; and
further wherein said first and second support frame members are disposed in spaced apart relationship, with one end of said first support frame member or said second support frame member coupled via said tilt control mechanism to form a pivot point, and with the remaining ends of said first support frame member and said second support frame member pivotally coupled to form three other pivot points, for tilting of said back support.

17. An adjustable chair as set forth in claim 16, wherein said first and second support frame members are substantially parallel.

18. An adjustable chair as set forth in claim 17, wherein said four pivot points form the vertexes of a substantial parallelogram.

19. An adjustable chair as set forth in claim 16, and further including:
a support base, said support base including a plurality of radially-outwardly and downwardly extending legs;
a height control adjustment mechanism coupled to and supporting said seat above said support base; and
a height control housing unit for housing said height control adjustment mechanism, said height control housing unit contained substantially entirely within said support base, extending downwardly between said legs.

20. An adjustable chair as set forth in claim 19, wherein the height of said seat is adjustable by said height control adjustment mechanism from a minimum of 12 inches to a maximum of 16 inches.

21. An adjustable chair comprising:
a tilt control mechanism;
a generally horizontal seat having a front-edge, a rear edge, opposite side edges and a surface for sitting;
a pair of first support frame members, each of said first support frame members having a forward end and a rearward end, said first frame support members operatively coupled at their forward ends to said tilt control mechanism to form a first pivot point, and said first frame support members pivotally coupled at their rearward ends to opposite sides of said seat to form a second pivot point;
a second support frame member having a forward end and a rearward end, said second support frame member pivotally coupled at its rearward end to the rear of said seat to form a third pivot point spaced apart from said second pivot point, and said forward end of said second support frame member pivotally coupled to a form a fourth pivot point above said support base, said fourth pivot point spaced apart from said first pivot point; and
a generally vertical back support having opposite side edges, said back support movably coupled on each side to one of said pair of first support frame members for positioning said back support above and proximate said rear edge of said seat and for tilting said back support under the control of said tilt control mechanism,
wherein the distance between said front edge of said seat and said back support defines the depth of said sitting surface of said seat, said back support selectively movable in the fore and aft direction relative to said seat, rearward movement of said back support increasing the depth of said sitting surface of said seat, and forward movement of said back support decreasing the depth of said sitting surface of said seat.

22. An adjustable chair as set forth in claim 21, wherein said back support frame or said pair of first support frame members comprise solid tubular members have a hollow tubular construction, said back support frame and said pair of first support frame members sized and shaped for telescoping engagement with each other.

23. An adjustable chair as set forth in claim 22, and further including:
a pair of arm rests, each of said arm rests comprising hollow tubular members for telescoping engagement with said back support and said pair of first support frame members.

24. An adjustable chair as set forth in claim 23, wherein each of said arm rests comprise:
an arm rest frame member; and
an arm pad member,
wherein said arm rest frame member and said arm pad member are sized and shaped for interlocking engagement so as to allow said arm pad member to slide relative to said arm rest frame member in a generally horizontal plane at an oblique angle relative to said seat and said back support, whereby movement of said arm pad member in one direction results in forward-and-outward adjustment of the position of said arm pad member relative to said seat and said back support, and movement of said arm pad member in the opposite direction results in rearward-and-inward adjustment of the position of said arm pad member relative to said seat and said back support.

25. An adjustable chair as set forth in claim 23, wherein each of said arm rests further includes:
a locking mechanism carried by at least one of said arm pad member and said arm rest frame member, and an opening in at least the other of said arm pad member and said arm rest frame member for selectively receiving said locking member.

26. A chair comprising:
a base member;
a generally horizontal seat;
a first support frame member having a forward end and a rearward end, one of said ends coupled to said seat and the other of said ends coupled to said base member;
a second support frame member having a forward end and a rearward end, one of said ends coupled to said seat and the other of said ends coupled to said base member;
a tilt control mechanism; and
a generally vertical back support positioned above and proximate a rear edge of said seat,
wherein said first support frame member and said second support frame member are disposed in spaced apart relationship, and one end of said first support frame member or said second support frame member is coupled via said tilt control mechanism to form a pivot point, and the remaining ends of said first support frame member and said second support frame member are pivotally coupled to form three other pivot points, and
further wherein said back support is connected to at least one of said support frame members for tilting movement relative to said seat.

27. A chair as set forth in claim 26, wherein said first support frame member and said second support frame member are substantially parallel.

28. A chair as set forth in claim 27, wherein said four pivot points form the vertexes of a substantial parallelogram.

29. A chair as set forth in claim 28, wherein said seat tilts to a lesser degree as said back support tilts, the height of said seat decreasing as said back support tilts in a backward direction, and the height of said seat increasing as said back support tilts in a forward direction.

30. An adjustable chair as set forth in claim 26, and further including:
a support base, said support base including a plurality of radially-outwardly and downwardly extending legs;
a height control adjustment mechanism coupled to and supporting said seat above said support base; and
a height control housing unit for housing said height control adjustment mechanism, said height control housing unit contained substantially entirely within said support base, extending downwardly between said legs.

31. An adjustable chair as set forth in claim 30, wherein the height of said seat is adjustable by said height control adjustment mechanism from a minimum of 12 inches to a maximum of 16 inches.

32. A chair comprising:
a support base;
a tilt control mechanism mounted above said support base;
a generally horizontal seat having a rear edge and opposite side edges;
a pair of first support frame members each having a forward end and a rearward end, said first support frame members operatively coupled at their forward ends to said tilt control mechanism to form a first pivot point, and said first support frame members pivotally coupled at their rearward ends to opposite sides of said seat to form a second pivot point;
a second support frame member having a forward end and a rearward end, said second support frame member pivotally coupled at its rearward end to the rear of said seat to form a third pivot point spaced apart from said second pivot point, and said forward end of said second support frame member pivotally coupled to a form a fourth pivot point above said support base, said fourth pivot point spaced apart from said first pivot point; and
a generally vertical back support positioned above and proximate said rear edge of said seat, said back support connected to one of said support frame members for tilting under the control of said tilt control mechanism.

33. A chair as set forth in claim 32, wherein said first pivot point and said fourth pivot point lie in a substantially horizontal plane.

34. A chair as set forth in claim 32, wherein said four pivot points form the vertexes of a substantial parallelogram, whereby said seat tilts to a lesser degree as said back support tilts under the control of said tilt control mechanism.

35. A chair as set forth in claim 32, and further including a tilt control housing unit for said tilt control mechanism, wherein said forward end of said second support frame member is pivotally coupled to said tilt control housing unit to form said fourth pivot point.

36. A chair as set forth in claim 32, wherein said back support is connected to said rearward end of said first support frame member.

37. In a chair including a generally horizontal seat having front, rear and opposite side edges, and a generally vertical back support positioned above and proximate the rear edge of the seat, an adjustable arm rest comprising:
an arm rest frame member positioned adjacent a side edge of the seat and forward of the back support; and
an arm pad member movably coupled to said arm rest frame member,
wherein said arm pad member is selectively movable for adjusting the position of said arm pad member in a generally horizontal plane relative to the seat and the back support.

38. An adjustable arm rest as set forth in claim 37, wherein said arm pad member is movable in said generally horizontal plane at an oblique angle relative to the side edges of the seat, whereby movement of said arm pad member in one direction results in forward-and-outward adjustment of the position of said arm pad member relative to the seat and the back support, and movement of said arm pad member in the opposite direction results in rearward-and-inward adjustment of the position of said arm pad member relative to the seat and the back support.

39. An adjustable arm rest as set forth in claim 38, wherein said arm rest frame member and said arm pad member are sized and shaped for interlocking engagement so as to allow said arm pad member to slide relative to said arm rest frame member.

40. An adjustable arm rest as set forth in claim 38, and further including means for releasably locking said arm pad member to said arm rest frame member in a selected position relative to said seat and said back support.

41. An adjustable arm rest as set forth in claim 40, wherein said releasable locking means comprises a locking mechanism carried by at least one of said arm pad member and said arm rest frame member, and an opening in at least the other of said arm pad member and said arm rest frame member for selectively receiving said locking member.

42. An adjustable arm rest as set forth in claim 40, wherein said locking mechanism comprises a spring-loaded detent member.

43. An adjustable chair comprising:
a support base, said support base including a plurality of radially-outwardly and downwardly extending legs;
a generally horizontal seat;
a height control adjustment mechanism coupled to and supporting said seat above said support base; and
a height control housing unit for housing said height control adjustment mechanism, said height control housing unit contained substantially entirely within said support base, extending downwardly between said legs.

44. An adjustable chair as set forth in claim 43, wherein said height control adjustment mechanism comprises a pneumatic mechanism, said pneumatic mechanism having at least two telescoping sections.

45. An adjustable chair as set forth in claim 43, wherein the height of said seat is adjustable by said height control adjustment mechanism from a minimum of 12 inches to a maximum of 16 inches.

46. In an adjustable tilt control mechanism for controlling the tilting of a chair, the adjustable tilt control mechanism having a spring mechanism to resist tilting, and a lead screw coupled to the spring mechanism for adjusting the resistance to tilting of the spring mechanism, the improvement comprising:
a self-centering spring member having first and second ends;
a crank arm coupled to the lead screw for rotating the lead screw in one direction when said crank arm is pivoted from a center position to one side, said crank arm capable of being pivoted back to said center position without rotating the lead screw, said crank arm including a portion for engaging and pushing said first end of said self-centering spring member as said crank arm is pivoted from said center position to said one side; and
a stop for preventing said second end of said self-centering spring member from substantial movement as said crank arm is pivoted from said center position to said one side,
whereby said self-centering spring member becomes spring-loaded as said crank arm is pivoted such that said self-centering spring member exerts a force tending to return said crank arm from said one side to said center position.

47. An adjustable tilt control mechanism as set forth in claim 46, wherein said crank arm is capable of pivoting to an opposite side of said center position for rotating the lead screw in an opposite direction, and further including:
a portion of said crank arm for engaging and pushing said second end of said self-centering spring member as said crank arm is pivoted from said center position to said opposite side, and
a stop for preventing said first end of said self-centering spring member from substantial movement as said crank arm is pivoted from said center position to said opposite side,
whereby said self-centering spring member becomes spring-loaded as said crank arm is pivoted such that said self-centering spring member exerts a force tending to return said crank arm from said opposite side to said center position.

48. An adjustable tilt control mechanism as set forth in claim 46, wherein said self-centering spring member is a torsion spring, and said first and second ends are wire legs of said torsion spring.
